(19) United States
(12) Patent Application Publication
(10) Pub. No.: US 2005/0077730 A1
(43) Pub. Date: Apr. 14, 2005

(54) Quick disconnect/connect shaft coupling

(76) Inventor: Bruno H. Thut, Chagrin Falls, OH (US)

Correspondence Address: PEARNE & GORDON LLP;12th Floor, Ohio Savings Building, 1801 East 9th Street, Cleveland, OH, 44114, US

(21) Appl. No.: 10/684,630

(22) Filed: Oct. 14, 2003

(51) Int. Cl. F16L 21/00

(52) U.S. Cl. 285/401

(57) ABSTRACT

A shaft coupling apparatus used in a pump assembly for pumping molten metal. The apparatus includes an impeller shaft, a drive shaft, and first and second coupling members. The first member engages the impeller shaft and includes a tube and two diametrically opposed pins. The second member includes a sleeve having an inner diameter adequate to receive the tube, a plate fixed to the sleeve having a mating surface cooperatively aligned with a mating surface of the impeller shaft, structure defining pin receiving slots, each slot adapted for guiding a pin into a retained position extending through the slot, and structure defining a plurality of voids in a sleeve outer surface. The pins and voids are rotatably engagable by a tool set such that the impeller and motor shafts are connectable and disconnectable by manual operation of the tool set. The apparatus may form a quick disconnect/connect gas injection shaft.

### FIELD OF THE INVENTION

This invention relates to a shaft coupling used in pump assembly and, in particular, to a quick disconnect/connect gas injection shaft.

### BACKGROUND OF THE INVENTION

Pumps used for pumping molten metal typically include a motor carried by a motor mount, a shaft connected to the motor at one end, and an impeller connected to the other end of the shaft. Such pumps may also include a base with an impeller chamber, the impeller being rotatable in the impeller chamber. Support members extend between the motor mount and the base and may include a shaft sleeve surrounding the shaft, support posts, and a tubular riser. An optional volute member may be employed in the impeller chamber.

Pumps of this type are designed with shaft bearings, impeller bearings and with bearings in the base that surround these bearings to avoid damage of the shaft and impeller due to contact with the shaft sleeve or base. The shaft, impeller, and support members for such pumps are immersed in molten metals such as aluminum, magnesium, copper, iron and alloys thereof. The pump components that contact the molten metal are composed of a refractory material, for example, graphite or silicon carbide.

These molten metal pumps are widely used in foundries and smelting facilities to convey molten metal from a melting or holding furnace to subsequent casting or metal forming stations. The pumps are also used to circulate the molten metal within a vessel. Typically, a motor mounted above a molten metal bath drives a rotatable impeller submerged in the bath. In operation, the rotating impeller draws molten metal from the bath and pumps it through a conduit routed to a subsequent station for further processing. The impeller is coupled to a lower end of a vertically oriented impeller shaft. An upper end of the impeller shaft extending above the molten metal bath is affixed to a female coupling member. In pump apparatuses of conventional design, the upper end portion of the impeller shaft is threaded. To secure the impeller shaft to the coupling member, the impeller shaft is screwed into a correspondingly internally threaded portion of the female coupling member. An end of a drive shaft extending from the motor is received in the coupling member and pinned thereto, providing a mechanical linkage between the rotating motor drive shaft and the pump impeller.

One alternative impeller shaft design is described in U.S. Pat. No. 5,622,481 to Thut. The '481 patent design features a female and male member held together by a graphite shear pin. This design protects the pump components and includes a shear pin with a shear strength value less than other components, but requires time for material assembly and disassembly.

An impeller shaft may need to be disconnected for a variety of reasons, including standard maintenance, impeller changes and repair of damaged components. The repair or replacement of a failed pump component is a costly, time consuming, and potentially dangerous task given the proximity of the hot molten metal. For example, if the impeller shaft fractures, the portion of the impeller shaft below the fracture point must be removed, along with the impeller pump, from the molten bath and the shaft portion disengaged from the impeller pump. Additionally, the portion of the impeller shaft above the fracture point must be unscrewed from the coupling member.

The molten metal processing market continues to demand improved pump and impeller designs from manufacturers which minimize pump down time. Accordingly, there is a need for a shaft coupling used in pump assembly which offers quick disconnect/connect features, ease of operator use, and safe operational conditions for personnel.

### SUMMARY OF THE INVENTION

The present invention is directed to an apparatus suitable for providing a connection between a motor and an impeller. The invention may be a shaft coupling used to provide a quick disconnect/connect gas injection shaft.

In a first embodiment, an apparatus for connecting a motor and an impeller includes an impeller shaft, a motor-driven drive shaft, and a first and second coupling member. The impeller shaft includes a first end and second end. The first end is coupled to an impeller and the second end has a mating surface. The motor-driven rotating drive shaft includes a first end and a second end. The first end is coupled to a motor.

The first coupling member engages the second end of the impeller shaft. The first coupling member includes two diametrically opposed pins extending outwardly from the impeller shaft.

The second coupling member engages the second end of the drive shaft. The second coupling member includes a sleeve, a plate, structure defining two pin receiving slots, and structure defining a plurality of voids. The sleeve has an inner diameter adequate to receive the second end of the impeller shaft within the sleeve. The plate is fixed to the sleeve and has a mating surface cooperatively aligned with the mating surface of the impeller shaft. Each of the pins are received into one of the pin receiving slots at one of two diametrically opposed pin entry points. The slots are adapted for guiding one of the pins into a retained position. The plurality of voids are in an outer surface of the sleeve.

The impeller shaft and the motor shaft are connectable and disconnectable by the application of rotational forces in opposing directions on the pins and the tool engaging surfaces.

The apparatus may include a gasket disposed between the mating surface of the impeller shaft second end and the mating surface of the second coupling member. The gasket is compressed to provide a seal between the impeller shaft and the second coupling member.

The impeller shaft may be constructed of graphite. The first coupling member may include a plurality of set screws extending from an outer surface of the tube into the impeller shaft. The apparatus may include a gas source located proximal the motor shaft first end, wherein the impeller shaft, the motor shaft, the first coupling member and second coupling member have structure defining a co-axial passage for injecting a gas therethrough.

The second coupling member may include a connecting tube coaxial to the motor shaft and fixed to the plate. The second coupling member may also include a plurality of set screws extending from an outer surface of the connecting tube into the motor shaft.

In a second embodiment, an apparatus for pumping molten metal includes a submergible impeller housing, a rotatable impeller disposed within the impeller housing, a motor disposed remote from the impeller, an impeller shaft, a first coupling member, and a second coupling member.

The impeller shaft has a first and second end. The first end is coupled to the impeller and extends through an opening in the pump housing. The second end has a mating surface. The first coupling member engages the second end of the impeller shaft. The first member includes a tube defining an inner opening that receives the second end of the impeller shaft and two diametrically opposed pins extending outwardly from the tube.

The second coupling member engages the second end of the drive shaft. The second member includes a sleeve having an inner diameter adequate to receive the tube within the sleeve, a plate fixed to the sleeve having a mating surface that abuts the mating surface of the impeller shaft, structure defining two pin receiving slots, wherein each of the pins are received into one of the slots at one of two diametrically opposed pin entry points, whereby the slots are adapted for guiding one of the pins into a retained position extending through one of the slots, and structure defining a plurality of tool engaging regions in an outer surface of the sleeve.

The first coupling member and the second coupling member are connectable and disconnectable by the application of rotational forces in opposing directions on the pins and the tool engaging surfaces.

A method for assembling an impeller shaft in a pump for pumping molten metal in accordance with the present invention is included. The method as disclosed has numerous steps.

A first step in the method is providing an impeller shaft having a first end and a second end, the first end being adapted to be connected to an impeller and the second end having a mating surface. An additional step is providing a rotatable drive shaft having a first end and a second end, the first end being coupled to a motor. Two additional steps include providing a first coupling member including a tube defining an inner opening that receives the second end of the impeller shaft, and two diametrically opposed pins extending outwardly from the tube, and connecting the first coupling member to the second end of the impeller shaft.

The next step of the method is providing a second coupling member including a sleeve having an inner diameter effective to receive the tube within the sleeve, a plate fixed to the sleeve having a mating surface cooperatively aligned with the mating surface of the impeller shaft, structure defining two pin receiving slots in the sleeve, each slot including a first pin entry channel and a second pin retention channel extending transverse to the pin entry channel, and at least two tool engaging surfaces on an external surface of the sleeve. The second coupling member is then connected to the second end of the drive shaft.

The next steps of the method include a tool set. The next step is providing a first wrench including a generally U-shaped cavity for receiving the tube and lugs extending therefrom having opposing recesses adapted to receive the pins. Next, a second wrench is provided including a generally U-shaped cavity having a size and configuration for receiving the tool engaging surfaces of the second coupling member.

The pins are next inserted into the pin entry channels of the second coupling member. An operator of the method may then engage the tool engaging surfaces of the second coupling member with the cavity of the second wrench, and position the pins into the recesses of the lugs of the first wrench.

The method is completed by rotating at least one of the first wrench and the second wrench to move the pins into the pin retention channels, thereby removably connecting the impeller shaft to the drive shaft.

The method may further include the steps of providing a gasket, disposing the gasket between the mating surface of the impeller shaft second end and the mating surface of the second coupling member, and compressing the gasket to form a seal between the impeller shaft and the second coupling member.

A device constructed in accordance with the present invention advantageously eliminates lengthy assembly and disassembly time required by conventional shafts. As required, the impeller shaft may be quickly disconnected from the motor drive shaft. In this process, a tool set may be used to disconnect a first coupling member engaged to the impeller shaft from a second coupling member engaged to the drive shaft. A first wrench of the tool set is used to apply rotational force to the impeller shaft in a direction opposite the rotational direction of the drive shaft. At the same time, a second wrench of the tool set is used to engage a tool engaging surface of the second coupling member to stabilize the drive shaft. An operator may apply a rotational force in the same direction as the rotational direction of the drive shaft to disconnect the impeller shaft from the drive shaft.

Many additional features, advantages and a filler understanding of the invention will be had from the accompanying drawings and the detailed description that follows. It should be understood that the above Summary of the Invention describes the invention in broad terms while the following Detailed Description of Preferred Embodiments describes the invention more narrowly and presents preferred embodiments which should not be construed as necessary limitations of the broad invention as defined in the claims.

### BRIEF DESCRIPTION OF THE DRAWINGS

FIG. 1 is a front elevational view, partially in section, of a pump including an apparatus constructed in accordance with the present invention;

FIG. 2 is an exploded perspective view of the apparatus of FIG. 1, showing a drive shaft, an impeller shaft and a tool set; and

FIG. 3 is a front elevational view, partially in section, of the apparatus of FIG. 1, as seen approximately from a plane taken along the line 3-3 of FIG. 1.

### DETAILED DESCRIPTION OF PREFERRED EMBODIMENTS

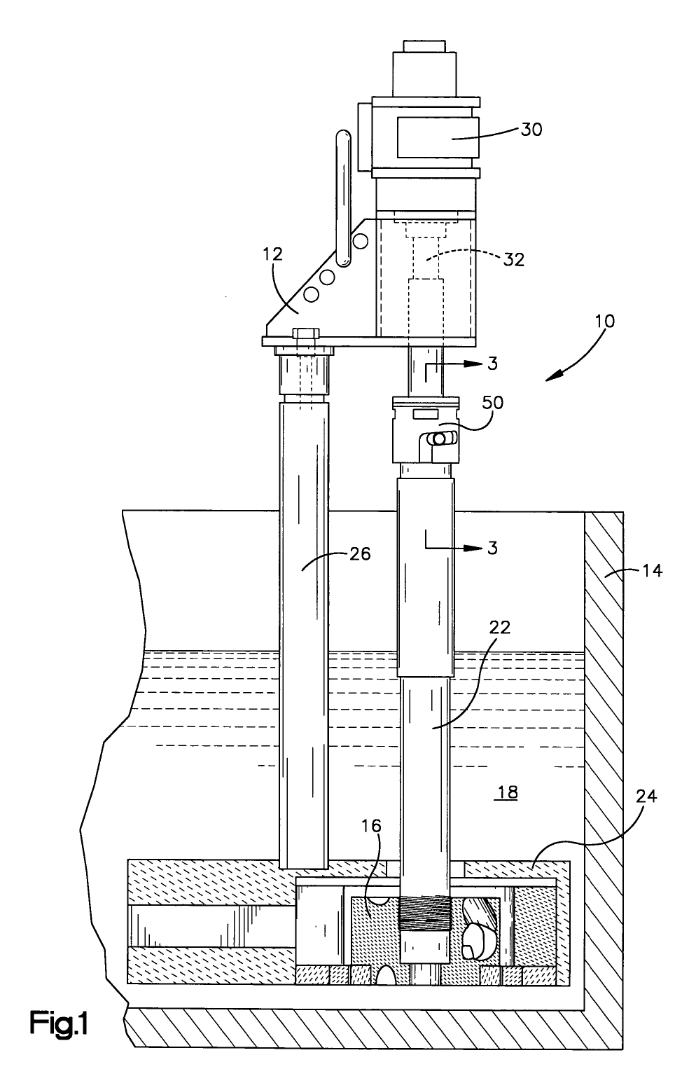

Referring to FIG. 1, an apparatus 10 for pumping molten metal embodying the present invention is illustrated. The apparatus 10 is mounted to a support fixture 12 disposed within a molten metal containment structure or vessel 14. The pump apparatus 10 includes at least one rotatable impeller 16 which in operation draws molten metal from a molten metal bath 18 and pumps the molten metal through a conduit 20 to a subsequent processing station or furnace (not shown). It should be understood that the apparatus of the present invention is not limited to the pump shown in the drawings, but rather is applicable to any motor shaft/impeller shaft coupling in a pump for pumping molten metal.

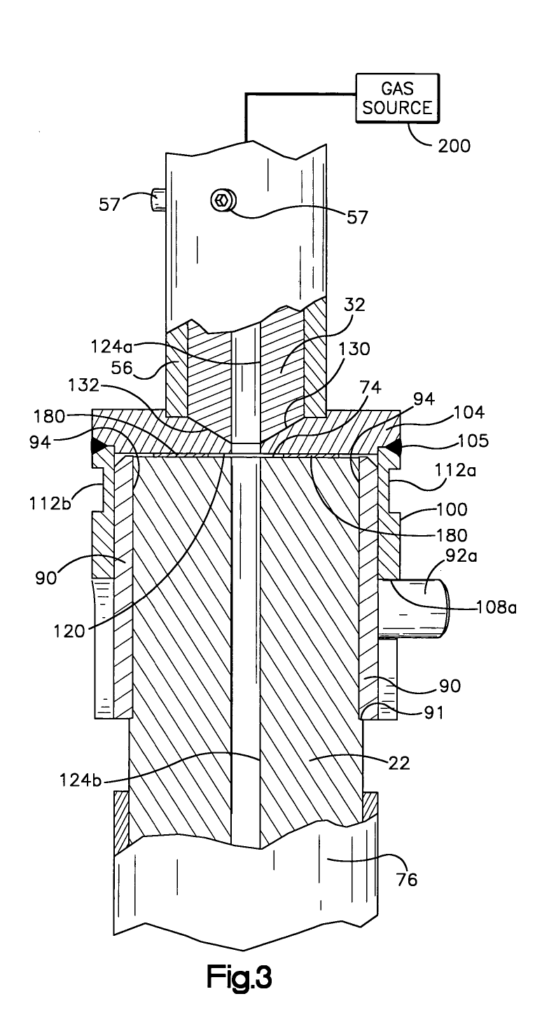

The pump apparatus 10 illustrated includes a gas injection shaft as best shown in FIG. 3. Gas is injected into the molten metal to react with impurities within the molten metal bath. Types of gas conventionally used include nitrogen, argon, and chlorine, among others. The specific gas selected for injection is based upon the type of impurity to be removed. After injection of the gas, a reaction takes place between the gas and the impurities and reaction products float to the surface. The products are periodically removed by a manual or semi-automatic skimming operation. The present invention is illustrated with a gas injection shaft for exemplary purposes only. It should be apparent to others with ordinary skill in the art that the present invention may be practiced with other types of pump apparatus not including a gas injection through the shaft.

Referring again to FIG. 1, the impeller 16 is enclosed within a pump housing 24 submerged in the molten metal bath. Thus, the impeller 16 is in fluid communication with the conduit 20 and is affixed to a decreased diameter portion of an impeller shaft 22. The pump housing 24 is supported by a support post 26 extending from the support fixture 12. A motor 30 is mounted atop the support fixture 12 and has a downwardly extending drive shaft 32. It should be apparent to others with ordinary skill in the art that in the practice of the present invention, the length and diameter of the shafts 22, 32 as well as the size and shape of the impeller will change pursuant to application requirements.

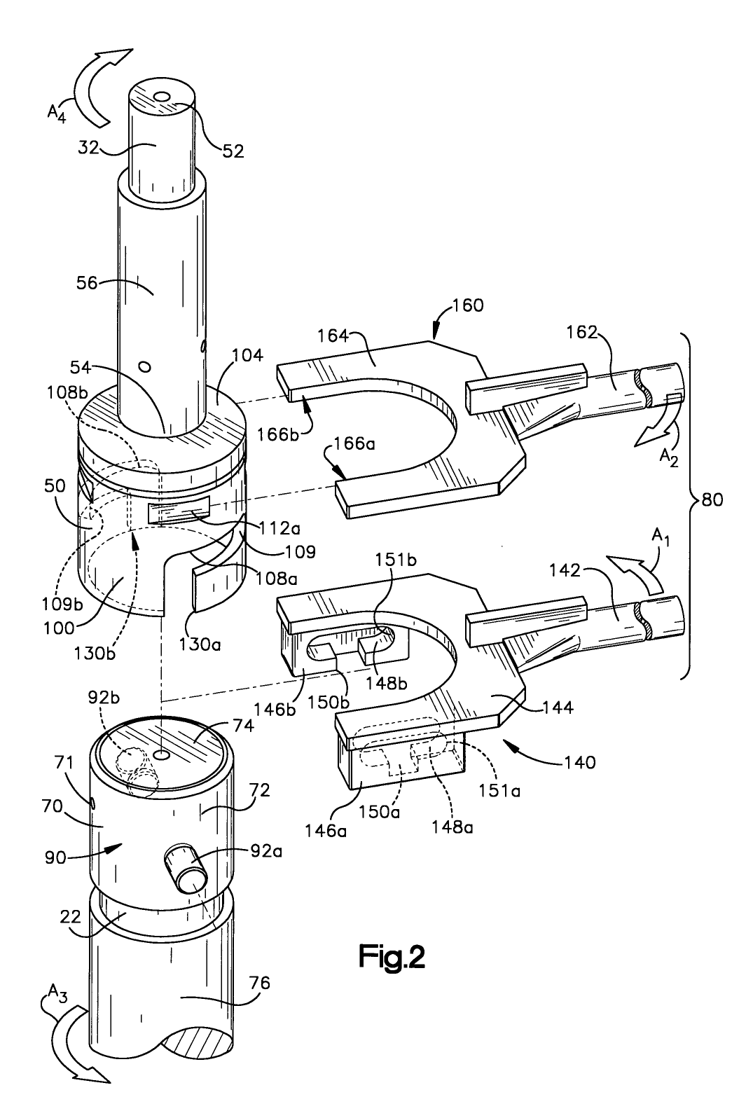

As illustrated, a first or lower coupling member 70 engages a second or upper coupling member 50 (best shown in FIG. 2) to provide a quick connect/disconnect shaft assembly. In one embodiment, the lower coupling 70 is a male member and the upper coupling 50 is a female member. As shown in FIG. 3, the male coupling 70 inserts into the female coupling 50. As illustrated in FIG. 1, both the coupling members 50, 70 are disposed above the surface of the bath 18. In one embodiment, the coupling members 50, 70 are made of steel or other suitable material having sufficient strength and heat resistance.

The lower coupling member 70 engages an end of the impeller shaft 22 that is above the molten metal bath 18 and the upper coupling member 50 engages an end of the motor shaft 32. In operation, the rotating motor drive shaft 32 drives the impeller 16. As discussed, the rotating impeller 16 stirs the molten metal such that it draws from the molten metal bath 18 and causes it to flow through the conduit 20.

Turning now to FIG. 2, an exploded perspective view of the apparatus 10 of FIG. 1 is illustrated. FIG. 2 shows an apparatus in accordance with the present invention used to connect a motor and an impeller. The apparatus includes an impeller shaft 22, a motor-driven drive shaft 32 and a tool set 80. The apparatus is illustrated in FIG. 3 in a partially coupled position. FIG. 3 is a front elevational view, partially in section, of the apparatus of FIG. 2, as seen approximately from a plane taken along the line 3-3 of FIG. 1.

The impeller shaft 22 has a first lower end (shown in FIG. 1) and second end 72 spaced upwardly therefrom. The first end is coupled to the impeller 16 and the second end 72 has a mating surface 74. As illustrated, the impeller shaft 22 is constructed of graphite. The graphite shaft 22 is covered by a metal sleeve 76 (e.g., steel) to protect the shaft from splashing from the molten metal bath. Alternatively, a metal wrap may be used to protect the shaft. The motor-driven drive shaft 32 provides rotational movement to the impeller. The drive shaft 32 has a first upper end 52 and a second lower end 54. The first end 52 is coupled to a motor 30 in a well-known manner (FIG. 1). A connecting tube 56 may be disposed over the outer circumference of the drive shaft 32. The tube 56 provides surface protection to the drive shaft 32 from the corrosive environment of the molten metal bath.

Referring again to FIG. 2, a lower coupling member 70 is shown engaging the second end 72 of the impeller shaft 22. The lower coupling member 70 includes a tube 90 and two pins 92a, 92b. A bottom of the tube 90 contacts a shoulder 91 of the impeller shaft 22 (best shown in FIG. 3). The tube 90 defines an inner opening 94 that receives the second end 72 of the impeller shaft 22. The inner opening is best shown in FIG. 3. The two diametrically opposed pins 92a, 92b extend outwardly from the tube 90. As best seen in FIG. 3, the lower coupling member 70 is adapted to engage the upper coupling member 50. More specifically, the tube pins 92a, 92b engage in bayonet slots of the upper coupling member 50.

The lower coupling member 70 may include a plurality of set screws 71 extending from an outer surface of the tube into the impeller shaft to secure the tube 90 in place over the impeller shaft 22 (FIG. 2).

In one embodiment, the lower coupling member 70 may include a gasket 180. As shown in FIG. 3, the gasket is disposed between the mating surface 74 of the impeller shaft 22 and the mating surface 120 of the second coupling member 50. The gasket 180 may be compressed to provide a seal between the impeller shaft 22 and the second coupling member 50. The gasket may be a GRAPHOIL™ brand graphite gasket and be cemented to the impeller shaft 22.

The upper coupling member 50 engages the second end 54 of the drive shaft 32. The second coupling member 50 includes a sleeve 100, a plate 104, structure in the sleeve defining two pin receiving slots 108a, 108b and structure defining a plurality of tool engagement surfaces such as flats 112a, 112b in an outer surface of the sleeve 100. In the embodiment illustrated, the sleeve 100 has four flats. Two diametrically opposed flats 112a, 112b are illustrated in FIG. 3. The flats may be recessed into the side of the sleeve 100 as shown. Other variations of the flats are possible as would be apparent to one with ordinary skill in the art view of this disclosure such as flats which protrude beyond the outer diameter of the sleeve 100.

The upper coupling member 50 may include a plurality of set screws 57, illustrated in FIG. 3, extending from an outer surface of the connecting tube into the motor shaft 32 to secure the tube 56 in place over the drive shaft 32.

The sleeve 100 has an inner diameter effective to receive the tube 90 of the first coupling member 70 within the sleeve 100. The plate 104 is fixed to the sleeve 100 by welding or any suitable method. As shown, the plate is welded to the sleeve 100 to form a weld bead 105. The plate 104 may be cemented, threaded or alternatively fastened onto the drive shaft 32. The plate 104 includes a mating surface 120 cooperatively aligned with the mating surface 74 of the impeller shaft 22. The plate 104 further includes a conical-shaped recessed surface 130 that fixedly mates with a bottom surface 132 of the drive shaft 32.

The mating surfaces 74, 120 align to provide fluid communication between a first injection passage 124a in the drive shaft 32 and a second injection passage 124b in the impeller shaft. As illustrated, the passages 124a, 124b are co-axial and cooperate to form a path for the injected gas from a gas source 200 proximal to the motor shaft 32 first end 52 to the molten metal bath 18.

As discussed, structure in the sleeve of the upper coupling member 50 defines two pin receiving slots 108a, 108b. As the apparatus 10 is engaged by an operator, each of the pins 92a, 92b are received into one of the slots 108a, 108b at one of two diametrically opposed pin entry points 130a, 130b extending generally along the shaft axis. Each slot 108a, 108b is designed for guiding one of the pins 92a, 92b into a retained position, as shown in FIG. 3. As illustrated, the slot and pin configuration is known as a bayonet style connection.

After an operator manually engages the bayonet style connection, a tool set 80 is used to tighten the connection between the two coupling members 50, 70. The tool set 80 is used by the operator to engage structure of upper coupling member 50 defining a plurality of flats 112a, 112b in an outer surface of the sleeve 100. At least one of the pins 92a, 92b and at least one of the flats 112a, 112b are rotatably engagable by the tool set 80 such that the impeller shaft 22 and the motor shaft 32 are connectable and disconnectable by manual operation of the tool set 80. For example, as the pin 92a enters the receiving slot 108a, the upper member 50 and lower member 70 begin to compress together and form a connection. The further distance the pin 92a travels up the slot toward the termination of the slot, the tighter the connection becomes between the upper member 50 and lower member 70. Conversely, as the pin 92a slides toward the mouth of the receiving slot 108a, the connection becomes weaker.

In the illustrated embodiment, a first lower tool wrench 140 includes a handle 142, a wrench jaw 144 and two lug blocks 146a, 146b. The lug blocks 146a, 146b include a pin engaging horizontally extending cavity defined by cavity walls 148a, 148b. The cavity includes a vertical entry point 150a, 150b and two semi-circular shaped termination portions 151a, 151b, both adapted for engaging the pins 92a, 92b of the first connecting member 70. The second upper tool 160 includes a handle 162 and a wrench jaw 164 having two flat engaging surfaces 166a, 166b. The individual parts of the lower tool 140 and the individual parts of the upper tool 160 can be assembled by welding or any other suitable method.

To complete the assembly of the apparatus, the pins 92a, 92b are slipped into the lug blocks 146a, 146b through two vertical entry points 150a, 150b into horizontally extending cavities 148a, 148b of the first tool 140. Likewise, the second tool 160 is manipulated such that the two flat engaging regions 166a, 166b engage the two flats 112a, 112b. In the illustrated embodiment, the flats 112a, 112b engaged are diametrically opposed on the exterior surface of the second coupling member 50. As mentioned, other numbers of flats may be employed in the practice of the present invention. Once the first and second tools 140, 160 are properly engaged, an operator rotates the first tool 140 in a direction A₁ and the second tool 160 in a direction A₂.

The tool movement described above advantageously rotates the impeller shaft 22 in a direction A₃ and the motor shaft 32 in a direction A₄. The pins 92a, 92b of the resulting apparatus are rotated in the direction A₃ until the pins abut the rotational end 109a, 109b of the slots 108a, 108b such that the couplings 50, 70 are removably fixed to each other. The direction A₃ may be opposite to a direction of operational rotation A₄ of the motor shaft. In practice of the invention, if the drive shaft 32 is connected to the motor 30 prior to use of the tool set 80, the operator in effect relatively stabilizes the motor shaft while rotating the impeller shaft in a direction A₃. In one embodiment, the tightening of the couplings 50, 70 to each other further acts to decrease the distance between the mating surfaces 74, 120 and consequently compresses the gasket 180.

In the illustrated embodiment, no additional mechanism is required to maintain the shafts 22, 32 in their assembled position. In operation of the pump as illustrated, the motor drives the drive shaft in a clockwise rotational direction, as shown by A₄. This direction A₄ acts to advantageously maintain the couplings 50, 70 of the shaft apparatus 10 in its engaged position. Although not wanting to be bound by theory, the compressed gasket 180 may act to retain the shafts 22, 34 in an engaged position.

Many modifications and variations of the invention will be apparent to those of ordinary skill in the art in light of the foregoing disclosure. Therefore, it is to be understood that, within the scope of the appended claims, the invention can be practiced otherwise than has been specifically shown and described.

1. An apparatus for connecting a motor and an impeller of a pump for pumping molten metal, the apparatus comprising:
a) an impeller shaft having a first end and second end, said first end being coupled to an impeller and said second end having a mating surface;
b) a motor-driven rotating drive shaft having a first end and a second end, said first end being coupled to a motor;
c) a first coupling member engaging said second end of said impeller shaft, said first coupling member comprising two diametrically opposed pins extending outwardly from said impeller shaft; and
d) a second coupling member engaging said second end of said drive shaft, said second coupling member comprising:
i) a sleeve having an inner diameter effective to receive said second end of said impeller shaft within said sleeve;
ii) a plate fixed to said sleeve having a mating surface cooperatively aligned with said mating surface of said impeller shaft;
iii) structure defining two pin receiving slots in said sleeve, wherein each of said pins are received into one of said slots at one of two diametrically opposed pin entry points, whereby said slots are adapted for guiding each of said pins into a retained position; and
iv) at least two tool engaging surfaces on an outer surface of said sleeve;
e) wherein said impeller shaft and said motor shaft are connectable and disconnectable by the application of rotational forces in opposing directions on said pins and said tool engaging surfaces.

2. The apparatus of claim 1 further comprising a gasket disposed between said mating surface of said impeller shaft second end and said mating surface of said second coupling member, whereby said gasket is compressed to provide a seal between said impeller shaft and said second coupling member.

3. The apparatus of claim 1 wherein said impeller shaft is comprised of graphite.

4. The apparatus of claim 1 wherein said first coupling member comprises a tube defining an inner opening that receives said second end of said impeller shaft, and said pins extend from said tube.

5. The apparatus of claim 1 wherein said first coupling member comprises a plurality of set screws extending from an outer surface of said tube into said impeller shaft.

6. The apparatus of claim 1 comprising a gas source located proximal said motor shaft first end, wherein said impeller shaft, said motor shaft, said first coupling member and said second coupling member have structure defining a co-axial passage for injecting a gas therethrough.

7. The apparatus of claim 1 wherein said second coupling member comprises a connecting tube coaxial to said motor shaft and fixed to said plate and a plurality of set screws extending from an outer surface of said connecting tube into said motor shaft.

8. A coupling assembly for coupling a motor-driven shaft and an impeller shaft of pump for pumping molten metal, the coupling assembly comprising:
a) a first coupling member adapted to engage an end of an impeller shaft, said first coupling member comprising:
i) a tube defining an inner opening that receives said end of said impeller shaft; and
ii) two diametrically opposed pins extending outwardly from said tube; and
b) a second coupling member adapted to engage an end of a drive shaft, said second coupling member comprising:
i) a sleeve having an inner diameter effective to receive said tube within said sleeve;
ii) a plate fixed to said sleeve having a mating surface proximal a mating surface of said impeller shaft end;
iii) structure defining two pin receiving slots in said sleeve, wherein each of said pins are received into one of said slots at one of two diametrically opposed pin entry points, whereby said slots are adapted for guiding each of said pins into a retained position extending through one of said slots;
iv) a plurality of tool engaging surfaces on an outer surface of said sleeve; and
v) a connecting tube fixed to said plate and coaxial to said motor shaft;
c) wherein said first coupling member and said second coupling member are connectable and disconnectable by the application of rotational forces in opposing directions on said pins and said tool engaging surfaces.

9. The coupling assembly of claim 8 further comprising a gasket disposed between said mating surface of said impeller shaft end and said mating surface of said plate, whereby said gasket is compressed to provide a seal between said impeller shaft and said plate.

10. The coupling assembly of claim 8 wherein said first coupling member comprises a plurality of set screws extending from an outer surface of said tube into said impeller shaft.

11. The coupling assembly of claim 8 wherein said second coupling member comprises a plurality of set screws extending from an outer surface of said connecting tube into said motor shaft.

12. The coupling assembly of claim 8 wherein said first coupling member and said second coupling member have structure defining a co-axial passage for injecting a gas through said coupling assembly.

13. A pump for pumping molten metal comprising:
a) a submersible base having an inlet, an outlet and an impeller chamber;
b) a rotatable impeller disposed within said impeller chamber;
c) a motor disposed remote from said impeller;
d) an impeller shaft having a first end and second end, said first end coupled to said impeller and extending through an opening in said base and said second end having a mating surface;
e) a first coupling member engaging said second end of said impeller shaft, said first coupling member comprising:
i) a tube defining an inner opening that receives said second end of said impeller shaft; and
ii) two diametrically opposed pins extending outwardly from said tube; and
f) a second coupling member engaging said second end of said drive shaft, said second coupling member comprising:
i) a sleeve having an inner diameter effective to receive said tube within said sleeve;
ii) a plate fixed to said sleeve having a mating surface that abuts said mating surface of said impeller shaft;
iii) structure defining two pin receiving slots in said sleeve, wherein each of said pins are received into one of said slots at one of two diametrically opposed pin entry points, whereby said slots are adapted for guiding each of said pins into a retained position extending through one of said slots; and
iv) a least two tool engaging surfaces on an outer surface of said sleeve;
g) wherein said first coupling member and said second coupling member are connectable and disconnectable by the application of rotational forces in opposing directions on said pins and said tool engaging surfaces.

14. The apparatus of claim 13 further comprising a gasket disposed between said mating surface of said impeller shaft and said mating surface of said plate, whereby said gasket is compressed to provide a seal between said impeller shaft and said second coupling member.

15. The apparatus of claim 13 wherein said impeller shaft is comprised of graphite.

16. The apparatus of claim 13 wherein said first coupling member comprises a plurality of set screws extending from an outer surface of said tube into said impeller shaft.

17. The apparatus of claim 13 comprising a gas source located proximal said motor shaft first end, wherein said impeller shaft, said motor shaft, said first coupling member and said second coupling member have structure defining a co-axial passage for injecting a gas therethrough.

18. The apparatus of claim 13 wherein said second coupling member comprises a connecting tube coaxial to said motor shaft and a plurality of set screws extending from an outer surface of said connecting tube into said motor shaft.

19. A method for assembling an impeller shaft in a pump for pumping molten metal, comprising:
providing an impeller shaft having a first end and a second end, said first end being adapted to be connected to an impeller and said second end having a mating surface;
providing a rotatable drive shaft having a first end and a second end, said first end being coupled to a motor;
providing a first coupling member comprising a tube defining an inner opening that receives said second end of said impeller shaft, and two diametrically opposed pins extending outwardly from said tube; connecting said first coupling member to said second end of said impeller shaft;
providing a second coupling member comprising a sleeve having an inner diameter effective to receive said tube within said sleeve, a plate fixed to said sleeve having a mating surface cooperatively aligned with said mating surface of said impeller shaft, structure defining two pin receiving slots in said sleeve, each slot comprising a first pin entry channel and a second pin retention channel extending transverse to said pin entry channel, and at least two tool engaging surfaces on an external surface of said sleeve;
connecting said second coupling member to said second end of said drive shaft; providing a first wrench comprising a generally U-shaped cavity for receiving said tube and lugs extending therefrom having opposing recesses adapted to receive said pins; providing a second wrench comprising a generally U-shaped cavity having a size and configuration for receiving said tool engaging surfaces of said second coupling member; inserting said pins into said pin entry channels of said second coupling member; engaging said tool engaging surfaces of said second coupling member with said cavity of said second wrench;
positioning said pins into said recesses of said lugs of said first wrench; and
rotating at least one of said first wrench and said second wrench to move said pins into said pin retention channels, thereby removably connecting said impeller shaft to said drive shaft.

20. The method of claim 19 further comprising:
providing a gasket;
disposing said gasket between said mating surface of said impeller shaft second end and said mating surface of said second coupling member; and
compressing said gasket to form a seal between said impeller shaft and said second coupling member.
